(19) United States
(12) Patent Application Publication
(10) Pub. No.: US 2007/0109291 A1
(43) Pub. Date: May 17, 2007

(54) Portable electronic apparatus and portable music-reproducing apparatus

(75) Inventors: Kiyoshi Hoshino, Tokyo (JP); Kazuharu Shimoda, Saitama (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/454,871

(22) Filed: Jun. 19, 2006

(30) Foreign Application Priority Data
Nov. 11, 2005 (JP) 2005-328211

(51) Int. Cl. G09G 5/00

(52) U.S. Cl. 345/211

(57) ABSTRACT

The invention provides a portable electronic apparatus and a portable music-reproducing apparatus which realize power saving promotion, and life prolonging promotion for a display panel, and which prevent display quality from being deteriorated. A portable electronic apparatus (1) can instruct an EL-displaying portion (12) to perform clock display while realizing power saving promotion therefor. Thus, the portable electronic apparatus (1) can be given an added value without impairing any of main functions thereof. Also, even when the EL-displaying portion (12) is in an OFF state, picture display is returned back to the clock display by manually operating corresponding one of switches, and is returned back to an operation picture for AUDIO or the like by manually operating corresponding another one of the switches. Hence, no complicated operation is required for the portable electronic apparatus (1).

The present application is based on Japanese patent application No. 2005-328211, the entire contents of which are incorporated herein by reference.

### BACKGROUND OF THE INVENTION

1. Field of the Invention

The present invention relates to a portable electronic apparatus and a portable music-reproducing apparatus each having a displaying portion which is capable of displaying thereon information such as characters and an image, and more particularly to a portable electronic apparatus and a portable music-reproducing apparatus which are capable of realizing power saving promotion.

2. Description of Related Art

In recent years, portable electric apparatuses have been known each of which has a storing portion such as a hard disc drive or a flash memory, reproduces musical data stored in the storing portion, and outputs a sound through an outputting portion such as a headphone. Some portable electronic apparatuses have each a displaying portion constituted by an organic electro-luminescence (EL) display device or a light emitting diode (LED) for displaying thereon characters and an image. However, while the displaying portion displays thereon characters and an image, it is supplied with a power from a battery built in a main body. As a result, it becomes a problem to suppress power consumption required for the display.

A portable electronic apparatus which changes display of characters displayed on a display panel has been proposed as one that realizes the power saving promotion, when a battery voltage drops to a level equal to or lower than a given level and low voltage display control is set. This portable electronic apparatus, for example, is disclosed in the Japanese Patent Kokai No. 2004-178029 (refer to FIG. 3 and a paragraph [0013]).

According to the portable electronic apparatus disclosed in the Japanese Patent Kokai No. 2004-178029, sizes of characters displayed on a display panel are reduced, or lines of the characters are made slender while the sizes of the characters are held invariable, and moreover the sizes of the characters are reduced and at the same time, the lines of the characters are made slender, thereby realizing the power saving promotion.

According to the portable electronic apparatus disclosed in the Japanese Patent Kokai No. 2004-178029, however, since the power consumption is reduced by making the display area of the characters smaller, the visibility for the characters during the display in a low voltage phase is reduced. In addition, even when the display of the characters is changed, the same voltage as that in the normal phase is applied to a part of segments. Hence, in particular, in the case of the display panel constituted by an organic EL element, there is encountered such a problem that not only pattern baking of the segments is caused to generate luminance nonuniformity in the display panel, but also a life of the display panel is shortened.

### SUMMARY OF THE INVENTION

In the light of the foregoing, it is an object of the present invention to provide a portable electronic apparatus and a portable music-reproducing apparatus which realize power saving promotion and life prolonging promotion, and which prevent display quality from being deteriorated.

In order to attain the above-mentioned object, according to an aspect of the present invention, there is provided a portable electronic apparatus, including: a main body having a displaying portion; a storing portion provided in the main body for storing therein a plurality of power saving modes, at least one of which includes clock display to be displayed on the displaying portion; and a display-controlling portion for, when a given non-externally operating time elapses in a state in which a display image based on a function to be executed in the portable electronic apparatus is displayed on the displaying portion, instructing the displaying portion to perform the clock display containing a non-display state based on one selected among the plurality of power saving modes.

In addition, in order to attain the above-mentioned object, according to another aspect of the present invention, there is provided a portable electronic apparatus, including: a main body having a displaying portion including an EL display device; a storing portion provided in the main body for storing therein a plurality of power saving modes, at least one of which includes clock display to be displayed on the displaying portion; and a display-controlling portion for, when a given non-externally operating time elapses in a state in which a display image based on an operation relating to a sound or image to be executed in the portable electronic apparatus is displayed on the displaying portion, instructing the displaying portion to perform the clock display containing a non-display state based on one selected among the plurality of power saving display modes.

Also, in order to attain the above-mentioned object, according to still another aspect of the present invention, there is provided a portable music-reproducing apparatus, including: a main body having a displaying portion; a storing portion for storing therein musical data; a reproducing portion for reproducing the musical data stored in the storing portion; a display mode-selecting portion for, when a given non-externally operating time elapses in a state in which a display image relating to music reproduced by the reproducing portion is displayed, selecting one among a first display mode of changing picture display on the displaying portion to clock display to continuously display the clock display, a second display mode of changing the picture display on the displaying portion to the clock display, and after a lapse of a setting time, stopping power supply to the displaying portion to provide a non-display state, and a third display mode of changing the picture display on the displaying portion to the clock display to change luminance of the clock display with a lapse of time; and a display-controlling portion for changing a display content on the displaying portion to another one in accordance with the display mode selected by the display mode-selecting portion.

According to the present invention, power saving promotion and life prolonging promotion for the display panel can be realized, and display quality can be prevented from being deteriorated.

### BRIEF DESCRIPTION OF THE DRAWINGS

FIG. 1 is a perspective view showing a portable electronic apparatus according to an embodiment of the present invention;

FIGS. 2A, 2B and 2C are respectively a top plan view, a left side elevational view and a bottom view showing respective portions of the portable electronic apparatus according to the embodiment of the present invention;

FIG. 3 is a main circuit block diagram of the portable electronic apparatus according to the embodiment of the present invention;

FIG. 4 is a structural diagram showing group management in accordance with management data in a display-controlling portion shown in FIG. 3;

FIGS. 5A, 5B, 5C and 5D are respectively diagrams showing a top menu display image, an audio menu display picture, an appli menu display image, and a clock display picture as displayed images on an EL-displaying portion, shown in FIG. 3, of the portable electronic apparatus according to the embodiment of the present invention;

FIGS. 6A, 6B and 6C are respectively diagrams of an audio menu display state, a clock display state, and a non-display state, in which the EL-displaying portion shown in FIG. 3 is in an OFF state, showing a lapse of a first power saving display mode according to the embodiment of the present invention; and

FIGS. 7A, 7B, 7C and 7D are respectively diagrams of an audio menu display state, a light clock display state having high luminance, a dark clock display state having low luminance, and a non-display state, in which the EL-displaying portion shown in FIG. 3 is in an OFF state, showing a lapse of a second power-saving display mode according to the embodiment of the present invention.

### DETAILED DESCRIPTION OF PREFERRED EMBODIMENTS

An embodiment of the present invention will hereinafter be described in detail with reference to the accompanying drawings.

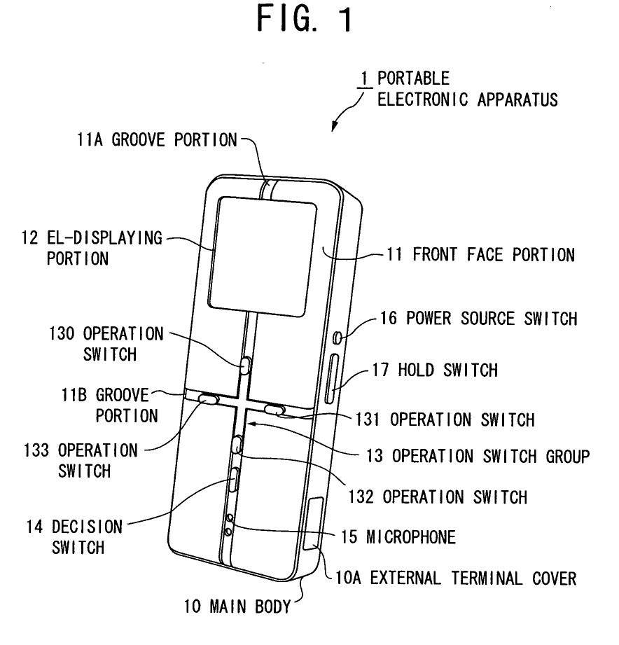

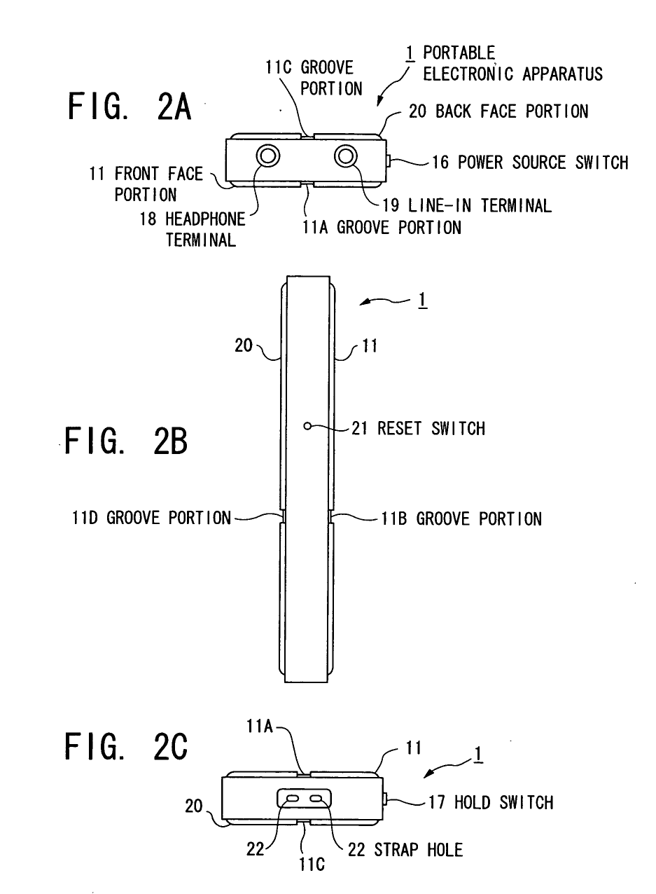

FIG. 1 is a perspective view showing a portable electronic apparatus according to an embodiment of the present invention. FIGS. 2A, 2B and 2C are respectively a top plan view, a left side elevational view and a bottom view showing respective portions of the portable electronic apparatus according to the embodiment of the present invention. This portable electronic apparatus 1 is a portable music-reproducing apparatus which can deal with data on pieces of music or recorded sounds (hereinafter referred to as “audio data”) and data on photographs, images or the like (hereinafter referred to as “photo data”).

[Construction of Portable Electronic Apparatus 1]

The portable electronic apparatus 1 includes a main body 10, an EL-displaying portion 12 constituted by an EL element and provided in a front face portion 11 of the main body 10, an operation switch group 13 including operation switches 130, 131, 132 and 133 with which the various operations of the portable electronic apparatus 1 are performed, a decision switch 14 with which an operation such as execution and decision of a function selected in accordance with an operation therefor is performed, a microphone 15 provided on a lower side of the front face portion 11 for collecting a sound to convert the sound thus collected into an electrical signal, and a power source switch 16 provided on a side face of the main body 10. Also, the portable electronic apparatus 1 includes a hold switch 17 provided on the side face of the main body 10 for making input operations with the various kinds of switches provided in the main body 10 valid or invalid through the switch operations, an external terminal cover 10A provided in the side face of the main body 10, a headphone terminal 18 and a line-in terminal 19 provided in a top face of the main body 10, a reset switch 21 provided in a left side face of the main body 10 for performing an operation for resetting the portable electronic apparatus 1, and a strap hole 22 which is provided in a bottom face of the main body 10 and through which a strap is threaded.

[Constructions of Portions]

The main body 10 is formed in box-like shape by subjecting an ABS resin to in mold forming. The main body 10 accommodates therein a lithium ion battery as a power source, a storing portion constituted by a semiconductor memory for storing therein the audio data having a format such as MP3 or WAV, and the photo data having a format such as JPEG or BMP, and circuit components for controlling the switches and an I/O terminal portion. In addition, groove portions 11A and 11B are provided in cross-like shape on the front face portion 11. The operation switch group 13 is disposed in an intersection portion between the groove portions 11A and 11B. The decision switch 14 is provided on a lower side of the groove portion 11A with respect to the operation switch group 13. In the front face portion which is partitioned into four rectangular parts by the groove portions 11A and 11B, the four partition areas, and the groove portions 11A and 11B are colored with different colors during the in mold forming, respectively. Incidentally, groove portions 11C and 11D are provided in cross-like shape on a back face portion 20 as well which is not illustrated in FIG. 1. Thus, four partition areas are formed on the back face portion 20 similarly to the front face portion 11.

The EL-lighting portion 12 is constituted by a 1.1 type color organic EL display device. Thus, the EL-lighting portion 12 has a wider angle of field than that of a liquid crystal display (LCD) device having the same size, and is excellent in responsibility of display. A display image size of the EL-lighting portion 12 is 96×96 dots.

The operation switch group 13 is formed by disposing the operation switches 130, 131, 132 and 133 in a cross direction. The operation switches 130, 131, 132 and 133 are depressed with a finger or the like of a user to be operated. In this embodiment, a function of volume adjustment or the like by the operation switches 130 and 132 is carried out in addition to a function of selecting desired one among items displayed on menu pictures.

Input for execution of the functions selected in the menus is carried out in addition to reproduction of the audio data selected in an audio menu which will be described later, and temporary stop of the reproduction with the decision switch 14.

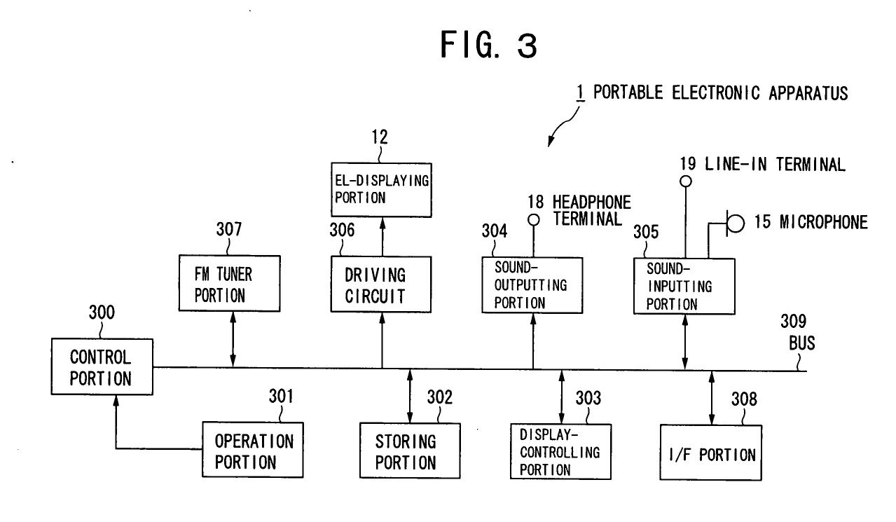

The microphone 15 collects the sound and outputs an analog signal corresponding to the sound thus collected. The audio data is recorded in a storing portion 302 (refer to FIG. 3) in accordance with the resulting analog signal.

The portable electronic apparatus 1 is operated from an OFF state to an ON state or from the ON state to the OFF state by depressing the power source switch 16 for a given long period of time.

The operations of all the switches provided in the main body 10 are made invalid by depressing the hold switch 17 for a given long period of time. In addition, a hold mode is released with the operations for all the switches made invalid in the hold mode by depressing the hold switch 17 for a given long period of time.

The external terminal cover 10A is made of a resin material having elasticity, and protects moisture and dirt from being stuck to a universal serial bus (CSB) connector through which the data such as the audio data and the photo data is inputted/outputted. At that, the lithium ion battery built in the portable electronic apparatus 1 of this embodiment of the present invention is charged with electricity from a power supplied from an external apparatus (e.g., a personal computer (PC)) connected to the USB terminal through a USB cable or the like.

FIG. 3 is a main circuit block diagram of the portable electronic apparatus according to this embodiment of the present invention. At that, the same portions as those described with reference to FIG. 1 and FIGS. 2A to 2C are designated with the same reference numerals, respectively.

A control portion 300 performs a clock function, decode and reproduction of the audio data, file system management for the audio and photo data, reproduction mode setting, equalizer setting during audio data reproduction phase, setting of a power saving display mode which will be described later, and user interface control.

An operation portion 301 outputs operation signals corresponding to operations for the switches provided in the main body 10 to the control portion 300.

The storing portion 302 stores therein firmware for operating the portable electronic apparatus 1, management data required to manage the audio data and the photo data, a program required for the reproduction, a setting program for setting the power saving display mode which will be described later, the audio data and the photo data.

A display-controlling portion 303 is systematized with respect to the audio data and the photo data, and menu items (AUDIO, APPLI, and SETTING) relating to the setting of the clock display or the like. The display-controlling portion 303 controls the image display of the EL-displaying portion 12 by referring to the management data stored in the storing portion 302. At that, the management data has a structure in which each menu item which has been described is further grouped into a plurality of items.

A sound-outputting portion 304 receives as its input audio data obtained through decode in the control portion 300 through a bus 309, converts the audio data thus received into analog data, and outputs the resulting analog data to the headphone terminal 18. In this case, the control portion 300 operates as a portion for reproducing the audio data.

A sound-inputting portion 305 has an encoder for converting an audio signal into audio data having a format with which the audio data can be reproduced by the portable electronic apparatus 1. Here, the format of the audio data to be reproduced is an MPEG-1 audio layers (MP3) format having a bit rate of 96 to 128 Kbps in (monaural) recording by the microphone 15, and thus is the MP3 having a bit rate of 96 to 128 Kbps in direct (stereo) encoding for the audio signal inputted through the line-in terminal 19. In addition, an audio signal in accordance with an FM broadcasting inputted through an FM tuner portion 307 which will be described later can also be converted into the MP3 file by the stereo recording having the bit rate of 96 to 128 Kbps.

A driving circuit 306 controls driving of the EL-displaying portion 12 by receiving as its input data corresponding to a display picture in accordance with a user operation from the control portion 300 through the bus 309.

An FM tuner portion 307 stereo-receives as its input an FM broadcasting by utilizing a code of a stereo headphone connected to the headphone terminal 18 as an antenna, and outputs the FM broadcasting thus received to the sound-outputting portion 304. Incidentally, the outputted audio signal can be recorded in the sound- inputting portion 305.

An interface (I/F) portion 308, when the external apparatus is connected to a USB terminal (not shown) or the like, controls an operation for inputting/outputting one or both of the audio data and the photo data for the bus 309.

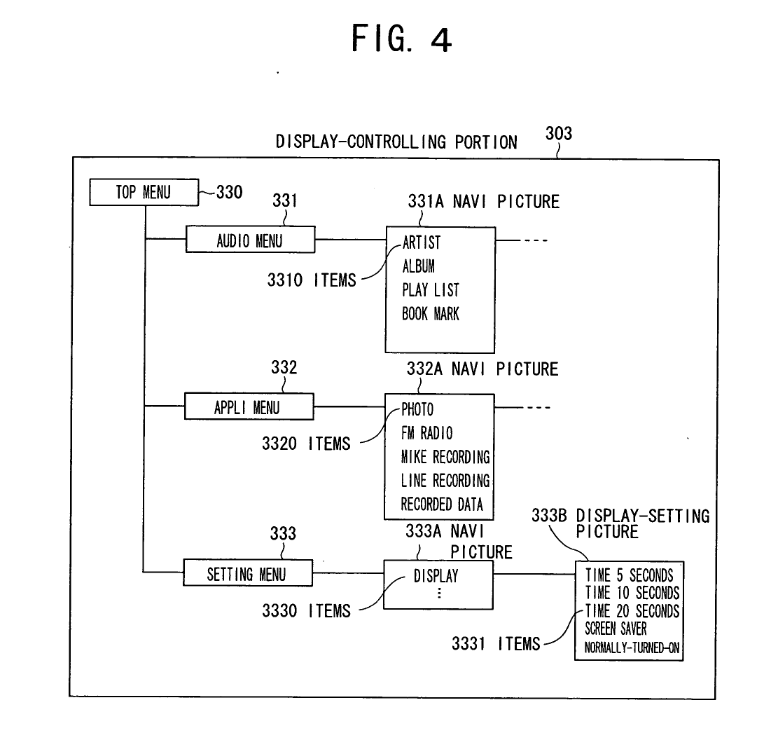

FIG. 4 is a structural diagram showing group management in accordance with the management data in the display-controlling portion 303 shown in FIG. 3.

The display-controlling portion 303 manages the data stored in the storing portion 302 every group. An audio menu 331, an appli menu 332, and a setting menu 333 are provided as a low rank group in a top menu 330 provided in the highest rank. Desired one of the audio menu 331, the appli menu 332, and the setting menu 333 is selected by operating the operation switch 130, 131, 132 or 133, and the decision switch 14 of the operation switch group 13 shown in FIG. 1 as a display mode-selecting portion.

A navi picture 331A containing therein items 3310 of an artist, an album, a play list, and a book mark is provided in a low rank group of the audio menu 331. While each of the items 3310 is further classified into a lower rank group, illustration thereof is omitted here.

With respect to the group of the audio menu 331, for the item of the artist, an associating file is displayed in which the audio data is classified every artist. For the item of the album, an associating file is displayed in which the audio data is classified every album. For the item of the play list, an associating file of the title is displayed which is obtained in accordance with a list of musical numbers and the order of pieces of music which the user sets for the audio data. Also, for the item of the book mark, a title of the audio data to which the user gives a book mark is displayed.

A navi picture 332A containing therein items 3320 of a photo, an FM radio, mike recording, line recording, and recorded data is provided in a low rank group of the appli menu 332. While each of the items 3320 is further classified into a lower rank group, illustration thereof is omitted here.

When the user selects the item of the photo with respect to the group of the appli menu 332, he/she can peruse photo data stored in the storing portion 302. When the user selects the item of the FM radio, he/she can listen to an FM broadcasting by operating a built-in FM radio. When the user selects the item of the mike recording, he/she can perform monaural recording such as voice recording using the microphone 15. When the user selects the item of the line recording, it is possible to record an audio signal outputted from an input unit connected to the portable electronic apparatus 1 through the line-in terminal 19. Also, when the user selects the item of the recording data, it is possible to reproduce the audio data which is recorded by the portable electronic apparatus 1 and is then stored in the storing portion 302.

While the various items relating to the setting for the portable electronic apparatus 1 are contained in a low rank group of the setting menu 333, only an item 3330 of display is illustrated herein. A display-setting picture 333B as the setting item in a power saving display mode is contained in the item 3330 of the display.

The display-setting picture 333B roughly contains therein selection items of a normal display mode, and two power saving display modes. In the normal display mode, after a lapse of a given time from the operation picture display or the menu picture display, the picture display on the EL-displaying portion 12 is changed to the clock display.

In a first power saving display mode, after a lapse of a given time from the operation picture display or the menu picture display, the picture display on the EL-displaying portion 12 is changed to the clock display, and after a lapse of a setting time, power supply to the EL-displaying portion 12 is stopped to provide a non-display state. In this embodiment, 5 seconds, 10 seconds or 20 seconds can be set as the setting time after the clock display has been made.

In addition, in a second power saving display mode, after a lapse of a given time from the operation picture display or the menu picture display, the picture display on the EL-displaying portion 12 is changed to the clock display, and luminance of the clock display is changed with a lapse of time. In this case, in a state of minimum luminance, the power supply to the EL-displaying portion 12 is stopped.

The clock display includes a design of a clock exhibiting a time, and an image size and a display pattern with which the user can readily and visually observe a digitally displayed segment in order to principally display a time.

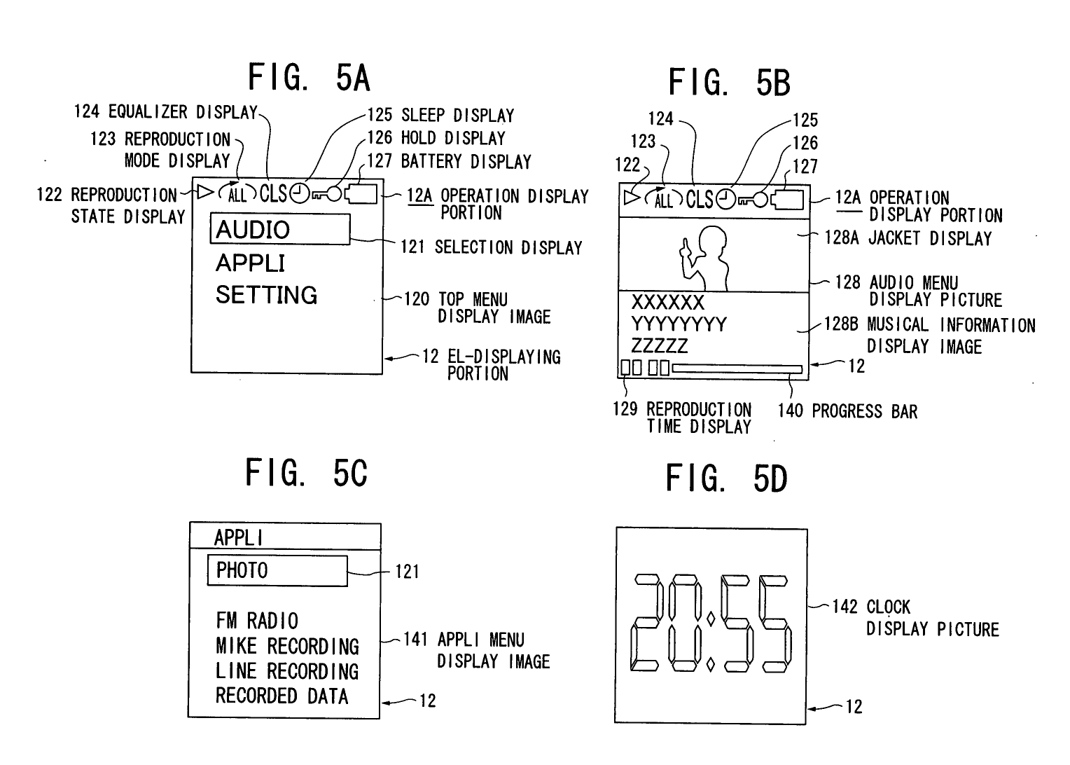

FIGS. 5A, 5B, 5C and 5D are respectively diagrams showing a top menu display image, an audio menu display picture, an appli menu display image, and a clock display picture as displayed images on the EL-displaying portion 12 of the portable electronic apparatus 1 according to this embodiment of the present invention.

As shown in FIG. 5A, functions of “AUDIO”, “APPLI”, and “SETTING” which can be executed in the portable electronic apparatus 1 are displayed as an operation display portion 12A on the top menu display image 120. Desired one of “AUDIO”, “APPLI”, and “SETTING” is displayed in the form of a high light form by moving a selection display 121 in accordance with the operation for the selection switch described above, and the decision switch 14 is operated, thereby selecting the corresponding desired function. In addition, reproduction state display 122 showing a reproduction state of the audio data, reproduction mode display 123 showing a reproduction mode (repeat) of the audio data, equalizer display 124 showing a mode of an equalizer for adjusting tone quality of the audio data, sleep display 125 showing setting of sleep in which the portable electronic apparatus 1 is shut down at a specified time, hold display 126 showing suitability of a hold mode, and battery display 127 showing a remaining power of the lithium ion battery are displayed in an upper portion of the screen.

An audio menu display picture 128 is displayed by selecting “AUDIO” from the top menu display image 120 shown in FIG. 5A. The above-mentioned operation display portion 12A, jacket display 128A corresponding to the audio data, a musical information display image 128B containing therein an artist name (XXX . . . ), an album name (YYY . . . ), a title (ZZZ . . . ), regeneration time display 129 displayed on a lower side of the screen, and a progress bar 140 showing progress of reproducing the audio data are displayed as shown in FIG. 5B in the audio menu display image 128. It should be noted that the reproduction time display 129 shown herein is different from the clock display stated in this application.

An appli display image 141 is displayed by selecting “APPLI” from the top menu display image 120 shown in FIG. 5A. Items of “PHOTO”, “FM RADIO”, “MIKE RECORDING”, “LINE RECORDING”, and “RECORDED DATA” are selectably displayed as shown in FIG. 5C on the appli menu display image 141.

A clock display picture 142 is displayed when a given time has elapsed in a state in which the display image shown in FIG. 5A, 5B or 5C has been displayed. A time is displayed herein in accordance with digital display. In the normal display mode, when the user performs no manual operation in a state in which the clock display image 142 is displayed, the clock display image 142 is displayed at all times. On the other hand, when the user performs the manual operation in the state in which the clock display image 142 is displayed, the display image before the display image is changed to the clock display image 142 is displayed.

[Operation in Power Saving Display Mode]

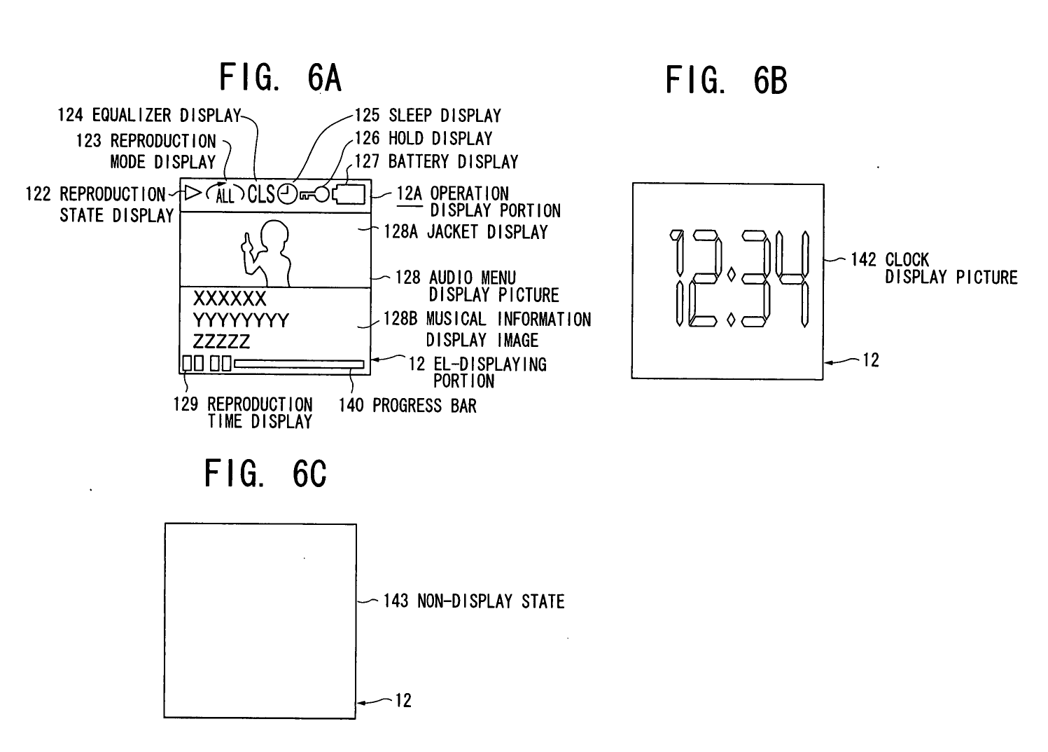

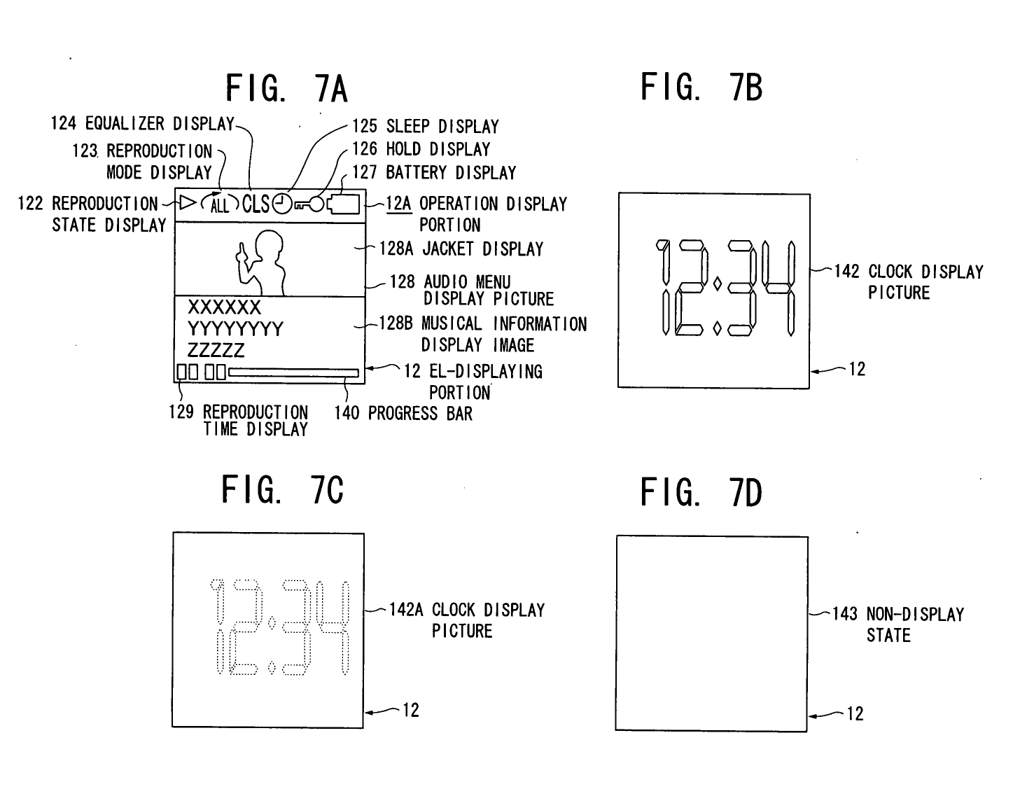

Next, power saving display modes of the portable electronic apparatus 1 will be described with reference to FIGS. 6A to 6C, and FIGS. 7A to 7D. The following description is given with respect to a case of proceeding to corresponding one of the power saving display modes in a state in which the audio menu is displayed.

[Operation in First Power Saving Display Mode]

FIGS. 6A, 6B and 6C are respectively diagrams of an audio menu display state, a clock display state, and a non-display state, in which the EL-displaying portion 12 is in an OFF state, showing a lapse of a first power saving display mode.

While the audio data shown in FIG. 6A is reproduced in a state in which the first power saving display mode is set in advance, after a lapse of a given time which is set as a time required for the proceeding to the clock display from a non-operation state in which a given non-operation time elapses, the control portion 300 instructs the EL-displaying portion 12 to display thereon the clock display picture 142 of the digital clock display shown in FIG. 6B. Hereinafter, “a given non-operation time” is referred to as “a given non-externally operating time”. Moreover, after a lapse of time (e.g., 5 seconds) set on the display setting picture 333B described above, the EL-displaying portion 12 is turned OFF by stopping the supply of the power from the driving circuit 306 to the EL-displaying portion 12 to provide a non-display state 143.

Here, when the user manually operates any one of the switches provided in the portable electronic apparatus 1, or when the user inserts or pulls out a terminal of a device into or from the headphone terminal 18, the line-in terminal 19 or the like, the supply of the power from the driving circuit 306 to the EL-displaying portion 12 is restarted. As a result, the EL-displaying portion 12 is turned ON again and the clock display image 142 shown in FIG. 6B is displayed.

In addition, when the user manually operates any one of the switches provided in the portable electronic apparatus 1 in a state in which the clock display picture 142 shown in FIG. 6B is displayed, the audio menu display picture 128 shown in FIG. 6A is displayed. At that, in the case as well where no audio data is reproduced, the same processing as that in the foregoing is executed.

[Operation in Second Power Saving Display Mode]

FIGS. 7A, 7B, 7C and 7D are respectively diagrams of an audio menu display state, a light clock display state having high luminance, a dark clock display state having low luminance, and a non-display state, in which the EL- displaying portion 12 is in an OFF state, showing a lapse of a second power saving display mode.

While the audio data shown in FIG. 7A is reproduced in a state in which the second power saving display mode is set in advance, after a lapse of a given time which is set as a time required for the proceeding from the non-manually operating state to the clock display, the control portion 300 instructs the EL-displaying portion 12 to display thereon the clock display picture 142 of the digital clock display shown in FIG. 7B. The operation until now is the same as that in the first power saving display mode.

Next, after a lapse of the time (e.g., 5 seconds) which is set on the display setting picture 333B described above, the supply of the power from the driving circuit 306 to the EL-displaying portion 12 changes with time. In accordance with this change in power supply, the luminance of the EL-displaying portion 12 changes. A clock display picture 142A shown in FIG. 7C shows a state in which the luminance is reduced. For this reason, the clock display on the EL-displaying portion 12 is performed by periodically repeating the luminance change of FIGS. 7B→FIG. 7C→FIG. 7D→FIG. 7C→FIG. 7B.

Here, when the user manually operates any one of the switches provided in the portable electronic apparatus 1, or when the user inserts or pulls out a terminal of a device into or from the headphone terminal 18, the line-in terminal 19 or the like, the audio menu display picture 128 shown in FIG. 7A is displayed. At that, in the case as well where no audio data is reproduced, the same processing as that in the foregoing is executed.

At that, as an exception of the case where the above-mentioned power saving display modes are set, the operation does not proceed to any one of the power saving display modes since while the recording operation is executed and while slide show of the photo data is executed, the processing to any of the power saving display modes impedes the functions which are being executed.

According to the embodiment described above, the clock display can be performed while the power saving promotion for the portable electronic apparatus 1 is realized. As a result, the portable electronic apparatus 1 can be given an added value without impairing any of the main functions thereof. In addition, even when the EL-displaying portion 12 is in the OFF state, the picture display is returned back to the clock display by manually operating corresponding one of the switches. Moreover, the picture is returned back to the operation picture for AUDIO or the like by manually operating corresponding another one of the switches. As a result, no complicated operation is required.

The display picture required for the manual operation is displayed, and in the state of requiring no manual operation, the EL-displaying portion 12 is instructed to display thereon the clock display or is turned OFF. Therefore, the continuous turn-ON time of the EL-displaying portion 12 is shortened to suppress the heat generation. As a result, the life prolonging promotion for the EL-displaying portion 12 is realized. In addition, the reduction in luminance of the EL-displaying portion 12 caused by the generation of the baking of the image on the EL-displaying portion 12 can be prevented for a long term.

Since there is provided the color organic EL-displaying portion 12 having a wider angle of field than that of the liquid crystal display device having the same size, even when the luminance of the clock display continuously changes in the second power saving display mode, the clock display can be visually observed in a wide range. In the second power saving display mode, a time can be confirmed without requiring the manual operation for the clock display. In addition, the reduction of the luminance is effective in suppression of the heat generation and the image baking. Thus, it is possible to obtain the portable electronic apparatus 1 having the EL-displaying portion 12 which is excellent in the power saving property with a small load while the novelty of the clock display is added thereto.

It should be noted that the present invention is not limited to the above-mentioned embodiment, and the various modifications can be made without departing from or changing the technical idea of the present invention. The portable electronic apparatus 1 is not also limited to the above-mentioned portable music-reproducing apparatus, and thus may be any other suitable electronic apparatus such as a mobile phone.

What is claimed is:

1. A portable electronic apparatus, comprising:
a main body having a displaying portion;
a selecting portion provided in the main body for selecting one among a plurality of power saving display modes, at least one of which includes clock display to be displayed on the displaying portion; and
a display-controlling portion for, when a given non-externally operating time elapses in a state in which a display image based on a function to be executed in the portable electronic apparatus is displayed on the displaying portion, instructing the displaying portion to perform the clock display containing a non-display state based on one selected among the plurality of power saving modes by the selecting portion.

2. A portable electronic apparatus according to claim 1, wherein:
the display-controlling portion, after a lapse of the given non-externally operating time, instructs the displaying portion to perform the clock display as a first power saving display mode contained in the plurality of power saving display modes, and when a given non-externally operating time further elapses after start of the clock display, stops supply of a power to the displaying portion.

3. A portable electronic apparatus according to claim 1, wherein:
the display-controlling portion, after a lapse of the given non-externally operating time, instructs the displaying portion to perform the clock display as a second power saving display mode contained in the plurality of power saving display modes, and changes luminance of the clock display with a lapse of time.

4. A portable electronic apparatus according to claim 1, wherein:
while image display for slide show is performed on the displaying portion in accordance with image data stored in a storing portion, the displaying-controlling portion performs no changeover to the clock display.

5. A portable electronic apparatus, comprising:
a main body having a displaying portion including an electro-luminescence(EL) display device;
a selecting portion provided in the main body for selecting one among a plurality of power saving display modes, at least one of which includes clock display to be displayed on the displaying portion; and
a display-controlling portion for, when a given non-externally operating time elapses in a state in which a display image based on an operation relating to a sound or image to be executed in the portable electronic apparatus is displayed on the displaying portion, instructing the displaying portion to perform the clock display containing a non-display state based on one selected among the plurality of power saving display modes by the selecting portion

6. A portable electronic apparatus according to claim 5, wherein:
the display-controlling portion, after a lapse of the given non-externally operating time, instructs the displaying portion to perform the clock display as a first power saving display mode contained in the plurality of power saving display modes, and when a given non-externally operating time further continues after start of the clock display, stops supply of a power to the displaying portion.

7. A portable electronic apparatus according to claim 5, wherein:
the display-controlling portion, after a lapse of the given non-externally operating time, instructs the displaying portion to perform the clock display as a second power saving display mode contained in the plurality of power saving display modes, and changes luminance of the clock display with a lapse of time.

8. A portable electronic apparatus according to claim 5, wherein:
while image display for slide show is performed on the displaying portion in accordance with image data stored in a storing portion, the displaying-controlling portion performs no changeover to the clock display.

9. A portable electronic apparatus according to claim 5, wherein:
while recording is performed in the portable electronic apparatus, the display-controlling portion performs no changeover to the clock display.

10. A portable music-reproducing apparatus, comprising:
a main body having a displaying portion;
a storing portion for storing therein musical data;
a reproducing portion for reproducing the musical data stored in the storing portion;
a display mode-selecting portion for, when a given non-externally operating time elapses in a state in which a display image relating to music reproduced by the reproducing portion is displayed, selecting one among a first display mode of changing picture display on the displaying portion to clock display to continuously display the clock display, a second display mode of changing the picture display on the displaying portion over to the clock display, and after a lapse of a setting time, stopping supply of a power to the displaying portion to provide a non-display state, and a third display mode of changing the picture display on the displaying portion to the clock display to change luminance of the clock display with a lapse of time; and
a display-controlling portion for changing a display content on the displaying portion to another one in accordance with the display mode selected by the display mode-selecting portion.
